(19) United States
(12) Patent Application Publication
(10) Pub. No.: US 2024/0005561 A1
(43) Pub. Date: Jan. 4, 2024

(54) METHOD FOR COMPRESSING MODEL DATA AND COMPUTER SYSTEM

(71) Applicant: Darmstadt Graphics Group GmbH, Darmstadt (DE)

(72) Inventor: Max Limper, Darmstadt (DE)

(21) Appl. No.: 18/252,303

(22) PCT Filed: Nov. 10, 2021
(86) PCT No.: PCT/EP2021/081227

§ 371 Date: May 9, 2023

(30) Foreign Application Priority Data
Nov. 10, 2020 (DE) 102020129559.6

(51) Int. Cl. G06T 9/00; G06T 3/40

(52) U.S. Cl. CPC G06T 9/001; G06T 3/40

(57) ABSTRACT

Compressing model data of a virtual 3D model includes the following steps: —receiving the model data which contains information on the virtual 3D model; —determining at least one characteristic variable of the model data; —receiving a target file size for the 3D model; —determining a preliminary mesh resolution of a preliminary virtual 3D model, a preliminary texture resolution of the preliminary virtual 3D model, and/or selecting at least one preliminary texture map to be used of the preliminary virtual 3D model on the basis of the at least one characteristic variable and on the basis of the target file size; and—compressing the model data on the basis of the preliminary mesh resolution, the preliminary texture resolution and/or the at least one preliminary texture map to be used, which generates compressed model data are obtained.

The invention relates to a method for compressing model data. The invention further relates to a computer system and to a computer program.

Digital three-dimensional models of objects are used in many different applications which range from CAD programs and applications for the representation of virtual reality or augmented reality up to (inner) architecture software and computer games.

However, it may happen that the corresponding 3D model is of too high quality so that the storage requirement for a specific application of the 3D model is too high. This is in particular problematic if corresponding files need to be downloaded first, as a correspondingly high data volume would thus be consumed. For example, applications for the representation of virtual reality often have higher quality requirements regarding the 3D model than applications for the representation of augmented reality.

Basically, it is sufficient for many applications if the 3D model is of a lower quality as the corresponding degree of specification is not relevant to the corresponding application.

However, a manual adaptation of the 3D model to predefined storage space and quality requirements is time-consuming and requires a high level of expertise from a user of the 3D model.

It is therefore the object of the invention to provide a method of compressing model data which permits a simple adaptation of the storage requirement of virtual 3D models.

According to the invention, the object is achieved by a method of compressing model data of a virtual 3D model. The method comprises the following steps:
a) receiving the model data containing information about the virtual 3D model;
b) determining at least one characteristic parameter of the model data;
c) receiving a target file size for the 3D model, wherein the target file size is a desired file size of the 3D model;
d) determining a preliminary mesh resolution of a preliminary virtual 3D model, a preliminary texture resolution of the preliminary virtual 3D model and/or selecting at least one preliminary texture map to be used of the preliminary virtual 3D model based on the at least one characteristic parameter and based on the target file size; and
e) compressing the model data based on the preliminary mesh resolution, the preliminary texture resolution and/or the at least one preliminary texture map to be used, thus obtaining compressed model data.

Here and hereinafter, the term “mesh resolution” is to be understood as a density of the polygons of the virtual 3D model.

Furthermore, the term “selecting at least one texture map to be used” is to be understood as selecting at least one texture to be used and/or the mapping rule associated with this texture by means of which the texture is projected onto the 3D model, more particularly onto the surface of a polygon mesh of the 3D model. This is also referred to as “texture mapping” in English.

The virtual 3D model may have a plurality of texture layers which are each associated with a specific partial aspect of the virtual 3D model, more particularly a primary color, lighting, surface reflections, surface roughness, surface orientation, transparency, non-transparency, etc.

These textures may each be projected onto the polygon mesh of the 3D model in accordance with a specific mapping rule.

The method according to the invention is based on the basic idea to compress the model data of the virtual 3D model by an adaptation of the mesh resolution, the texture resolution and/or the texture map used only to such an extent until the file size of the 3D model corresponds to the target file size, i.e. the desired file size.

The file size of the model data is thus reduced by reducing the density of the polygons of the 3D model, by reducing the texture resolution of the textures used, by using textures having a smaller file size, and/or by using fewer different types of textures.

To this end, it is first estimated based on the target file size and the at least one characteristic parameter of the model data, how the parameters of the virtual 3D model, i.e. the mesh resolution, the texture resolution and the texture maps used have to be adjusted to achieve the target file size.

In other words, the mesh resolution, the texture resolution and the texture maps used are not generally scaled down. Rather, these parameters are adjusted individually or together such that the size of the compressed model data corresponds (at least approximately) to the target file size.

Accordingly, a user can select a desired target file size, and the corresponding 3D model is automatically compressed such that the file size of the corresponding model data corresponds (at least approximately) to the target file size.

The file size of the 3D model is thus sufficiently reduced such that the 3D model is suitable for a specific application, a maximum possible quality of the 3D model being however maintained. The model data is accordingly not compressed more than necessary.

More particularly, the method according to the invention of compressing model data is a computer-implemented method of compressing model data of a virtual 3D model.

According to one aspect of the invention, the at least one characteristic parameter includes a file type of the model data, a file size of the model data, a file size per vertex and/or a file size per texel. In general terms, the at least one characteristic parameter is thus a parameter allowing an estimation of the change in the file size when changing the mesh resolution, the texture resolution and/or the texture map.

In other words, the at least one characteristic parameter allows an estimation of the preliminary mesh resolution, the preliminary texture resolution and/or the preliminary texture map to be used, such that the file size of the compressed model data corresponds (at least approximately) to the target file size.

Here and hereinafter, a “vertex” is meant to be a node of the polygon mesh of the virtual 3D model.

If the at least one characteristic parameter comprises, for example, the file size per vertex, i.e. the entire file size divided by the number of vertices, this parameter allows an estimation of the number of vertices to be removed from the 3D model to achieve the target file size.

If the at least one characteristic parameter comprises, for example, the file size per texel, i.e. the entre file size divided by the number of texels, this parameter thus allows an estimation of how much the resolution of the textures has to be reduced to achieve the target file size.

According to a further aspect of the invention, a file size of the compressed model data is determined and compared with the target file size. Based on the result of the comparison, the compressed model data is either output or further processed if the file size still substantially differs from the target file size. This is described in more detail below.

A further aspect of the invention provides that the following steps are performed if the file size of the compressed model data is larger than the target file size by more than a predefined difference size:
f) determining a further preliminary mesh resolution of a further preliminary virtual 3D model, a further preliminary texture resolution of the further preliminary virtual 3D model and/or selecting a further preliminary texture map to be used of the further preliminary virtual 3D model based on the compressed model data and based on the target file size; and
g) compressing the model data based on the further preliminary mesh resolution, the further preliminary texture resolution and/or the further preliminary texture map to be used.

The already compressed model data is thus compressed again if the file size of the compressed model data is larger than the target file size by more than the predefined difference size. Therefore, in case the file size of the compressed model data still differs too much from the target file size after the first compressing iteration, a new compression of the model data is performed.

For example, steps f) and g) are performed if the file size of the compressed model data differs from the target file size by more than 10% or by more than 5%.

Steps f) and g) are preferably performed if the file size of the compressed model data is larger than the target file size. In other words, the predefined difference size is thus equal to 0 in this case.

Steps f) and g) may be repeated several time, wherein a maximum number of iterations of steps f) and g) is limited to a predefined maximum value. More particularly, the compressed model data is output when the maximum number of iterations is reached.

The already compressed model data may thus be recompressed several times until the file size of the compressed model data is larger than the target file size by less than the predefined difference size. The maximum number of compression iterations may be limited to limit the computing time for compression, for example.

According to a further configuration of the invention, the following steps are performed if the file size of the compressed model data is smaller than the target file size by more than a predefined difference size:
h) determining a further preliminary mesh resolution of a further preliminary virtual 3D model, a further preliminary texture resolution of the further preliminary virtual 3D model and/or selecting a further preliminary texture map to be used of the further preliminary virtual 3D model based on the compressed model data and based on the target file size; and
i) up-scaling the model data based on the further preliminary mesh resolution, the further preliminary texture resolution and/or the further preliminary texture map to be used.

The already compressed model data is thus up-scaled if the file size of the compressed model data is smaller than the target file size by more than the predefined difference size. Therefore, in case the file size of the compressed model data differs too much downward from the target file size after the first compression iteration, the number of vertices and/or the texture resolution is/are increased and/or the texture map(s) used is/are changed to higher order textures or to more different textures.

The predefined difference size may be between 2% and 25% of the target file size, more particularly between 5% and 20% of the target file size, for example 10% of the target file size.

The predefined difference size is more particularly adjustable, for example freely adjustable so that a user can select the predefined difference size on his own.

According to a further aspect of the invention, steps h) and i) are repeated several times, wherein a maximum number of iterations of steps h) and i) is limited to a predefined maximum value. More particularly, the compressed model data is output when the maximum number of iterations is reached. The already compressed model data may thus be up-scaled several times, until the file size of the compressed model data is smaller than the target file size by less than the predefined difference size. The maximum number of iterations of the up-scaling may be limited, for example to limit the maximum computing time for up-scaling.

In particular, it may happen that the file size of the up-scaled model data is larger than the target file size. In this case, it is possible to perform steps f) and g) described above to compress the model data again.

Conversely, it may happen that the file size of the compressed model data is smaller than the target file size. In this case, steps h) and i) described above may then be performed to up-scale the model data again.

Accordingly, the model data is iteratively compressed and/or up-scaled so that the file size of the model data is iteratively brought to the target file size.

More particularly, the total number of iterations of steps f) and g) and of steps h) and i) may be limited to a maximum number. In this way, the total computing time for compressing the model data is limited.

In a further configuration of the invention, the model data is converted into a target file format to determine the at least one characteristic parameter. The target file format corresponds to the file format in which the compressed model data is to be output. Accordingly, the at least one characteristic parameter is determined in that file format which is also to be output. In this way, the preliminary number of vertices, the preliminary texture resolution and/or the at least one preliminary texture map to be used can be better estimated.

The target file format may in particular be selected by the user.

According to the invention, the object is further achieved by a computer system including at least one computing apparatus, in particular at least one sever, the computing apparatus having at least one computing module, wherein the computing module is configured to execute a method as described above. The computing module comprises at least one computing unit, for example at least one CPU, GPU, FPGA and/or ASIC.

The computing apparatus is in particular configured as a server or as a client-side computing apparatus. The computing apparatus may be configured as a computer, a laptop, a smart phone, a tablet or as another smart device, for example.

The computing apparatus particularly comprises a storage medium on which a computer program for executing the method described above is stored.

According to one aspect of the invention, the computer system has a client-side smart device, the client-side smart device being arranged to transmit the model data and/or the target file size to the computing apparatus. In other words, a user of the computer system can transmit the model data to the computing apparatus, in particular to the server by means of the client-side smart device and can select the target file size. The computing module of the computing apparatus compresses the model data in accordance with the specifications of the user and outputs the compressed model data. The compressed model data can then be transmitted to the client-side smart device.

According to the invention, the object is further achieved by a computer program having program code means which are arranged to execute a method as described above when the computer program is executed on a computing unit, in particular on a computing unit of a computing apparatus of a computer system as described above.

Here and hereinafter, “program code means” are to be understood as computer-executable instructions in the form of program code and/or program code modules in a compiled and/or un-compiled form which may be present in any programming language and/or machine language.

As to the advantages and further features of the computer program, reference is made to the above explanations regarding the method which equally apply to the computer program and vice versa.

One aspect of the invention provides that the computer program has a user interface, in particular a graphic user interface, the user interface having a sliding control, a selection list and/or a writable text box for setting the target file size. A user of the computer program may easily set the target file size by means of the graphic user interface or more specifically by means of the sliding control, the selection list and/or the writable text box.

For example, at least one tolerance size for the target file size may also be set by means of the user interface, wherein the at least one tolerance size indicates by which predefined difference size the file size of the compressed model data can deviate upward and/or downward from the target file size.

Further advantages and features of the invention will become apparent from the description below and from the accompanying drawings to which reference is made and in which:

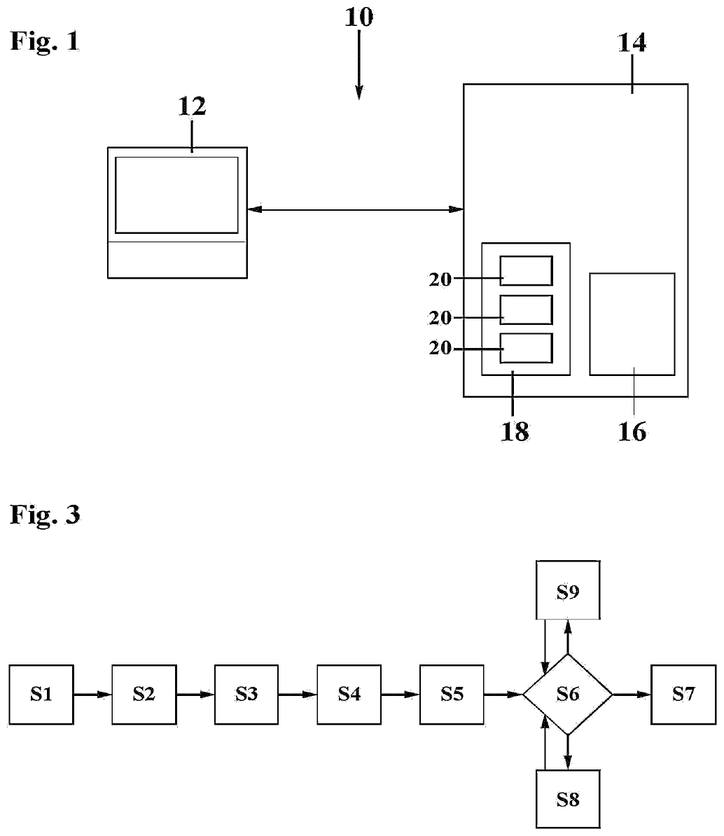

FIG. 1 schematically shows a computer system according to the invention;

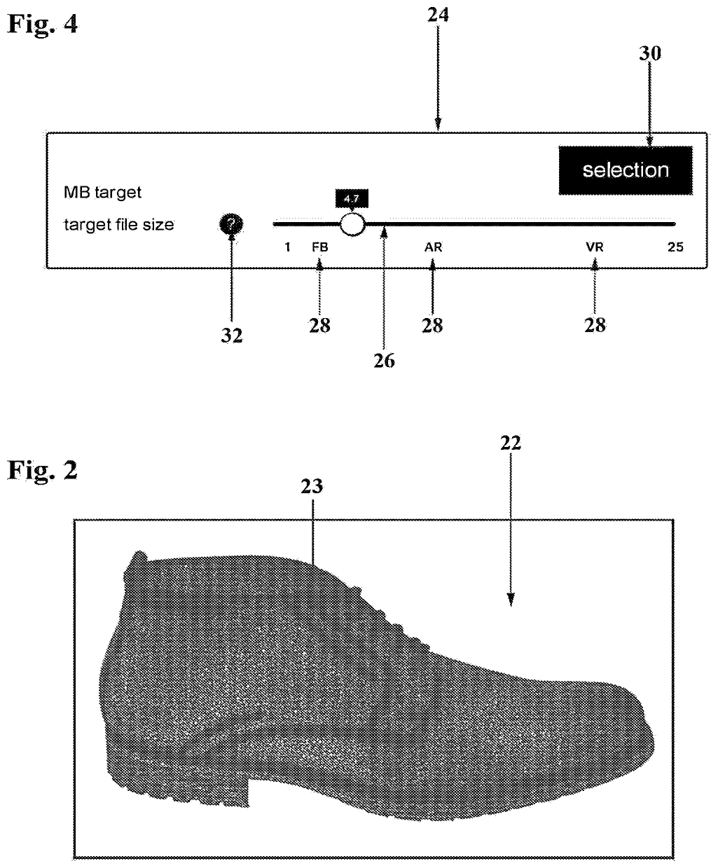

FIG. 2 shows a 3D model including a visible polygon mesh before compression;

FIG. 3 shows a flow chart of the steps of a method of compressing model data according to the invention;

FIG. 4 schematically shows a user interface of a computer program according to the invention;

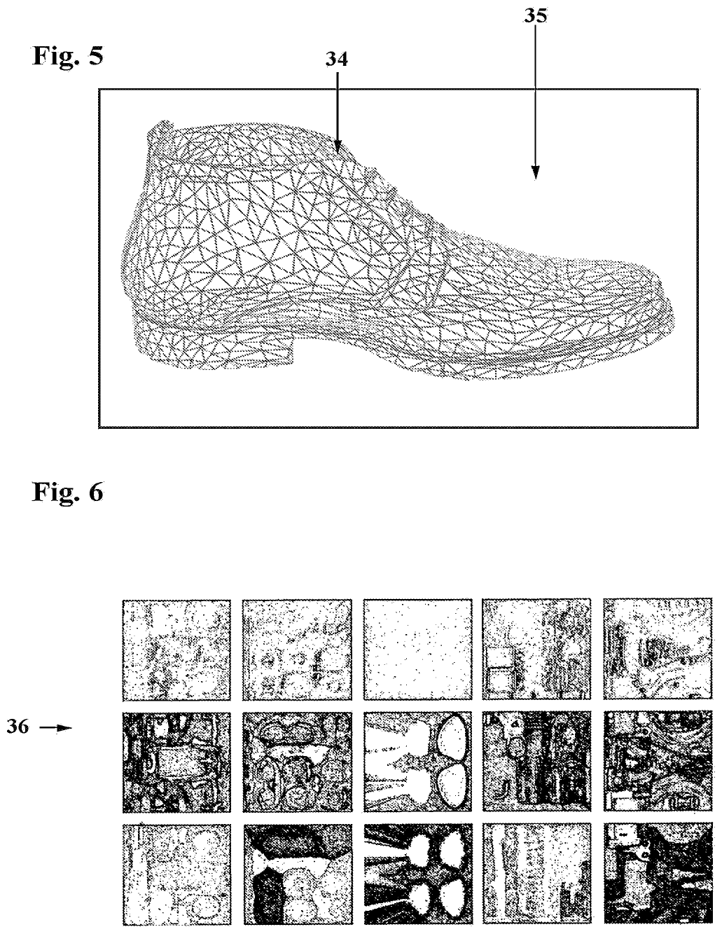

FIG. 5 shows the 3D model of FIG. 4 after compression;

FIG. 6 shows a set of textures of a virtual 3D model in high quality; and

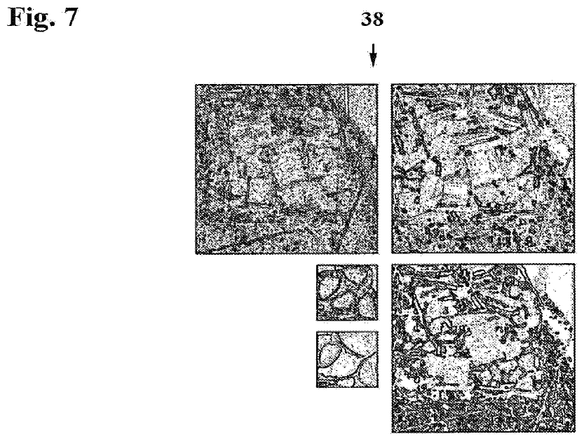

FIG. 7 shows a set of textures of the same virtual 3D model as in FIG. 6 in reduced quality.

FIG. 1 schematically shows a computer system 10 for the automatic compression of model data of a virtual 3D model.

The computer system 10 includes a client-side smart device 12 and a least one computing apparatus which is configured as a server 14 in the embodiment of the computer system 10 shown in FIG. 1.

Alternatively, the computing apparatus can also be configured as a client-side computing apparatus, as a computer, a laptop, a smart phone, a tablet or another smart device, for example.

Optionally, the computing apparatus can be identical with the client-side smart device 12.

It is also possible to provide a plurality of servers 14 which together form a computer network (“cloud”).

In the following, the embodiment shown in FIG. 1 in which the computing apparatus is designed as a server 14 is described without restriction of generality. However, as described above, it is also possible to use a client-side computing apparatus instead of the computing apparatus configured as a server 14.

The client-side smart device 12 is, for example, a PC, a laptop, a smartphone or a tablet. However, it may also be any other type of smart device.

The server 14 includes at least one storage medium 16 for storing data and a computing module 18.

The computing module 18 comprises a plurality of computing units 20, each of which may be configured as a CPU, a GPU, a field programmable gate array (FPGA), and/or an application specific integrated circuit (ASIC).

The client-side smart device 12 is connected in a signal-transmitting manner to the at least one server 14.

Here and hereinafter, a signal-transmitting connection is to be understood as a connection allowing data exchange. Accordingly, the smart device 12 and the at least one server 14 are thus connected for data transmission.

Preferably, the smart device 12 and the at least one server 14 are connected via Internet.

It is also conceivable that the client-side smart device 12 is connected to the server 14 via a local network, via LAN, for example.

FIG. 2 represents a virtual 3D model 22 of a shoe. The file size of this exemplary model is approximately 25 MB, for example, it thus involves a virtual 3D model of high quality.

The virtual 3D model 22 is substantially defined by a polygon mesh 23 and by one or more texture maps which project one or more textures onto the polygon mesh 23.

A high-quality virtual 3D model usually has a higher mesh resolution and/or a higher texture resolution than a simple virtual 3D model of the same object.

Furthermore, a high-quality virtual 3D model usually has more complex texture maps, i.e. the number of different textures or texture layers may be higher and/or the mapping rules associated with these structures can be more complex than for simpler virtual 3D models.

The virtual 3D model can include a plurality of texture layers which are each associated with a specific partial aspect of the virtual 3D model, in particular with a primary color, lighting, surface reflections, surface roughness, surface orientation, transparency, non-transparency, etc.

These textures are each projected onto the polygon mesh of the 3D model in accordance with a certain mapping rule.

Furthermore, each of these textures can have its own texture resolution.

Generally, different quality levels of the 3D model are required for different applications of virtual 3D models. For example, applications for the representation of virtual reality often have higher quality requirements regarding the 3D model than applications for the representation of augmented reality.

Accordingly, the high-quality, but storage-intense virtual 3D model 22 of FIG. 2 can for example have too high storage requirements for certain applications.

However, a manual adaptation of the 3D model to predefined storage space and quality requirements is time-consuming and requires a high level of expertise from a user of the 3D model.

Generally speaking, the computer system 10 is configured to automatically compress model data of a virtual 3D model transmitted from the client-side smart device 12 to the server 14.

For this purpose, a computer program for automatically compressing the virtual 3D model data is stored on the storage medium 16 of the server 14.

The computer program comprises program code means which are arranged to perform the steps of a method of compressing model data of a virtual 3D model as described below with reference to FIG. 3, when the computer program is executed on at least one of the computing units 20 of the server 14.

First, the model data is received which contain information about the virtual 3D model (step S1).

More specifically, the at least one server 14 receives the model data from the client-side smart device 12.

The model data is of a certain data type and has a certain file size.

The model data comprises at least information about the structure of a polygon mesh of the virtual 3D model, about the type of textures with which the polygon mesh is covered, and about the resolution of the textures.

In particular, the model data comprises information about the number of vertices of the polygon mesh, the respective positions of the vertices and the connections between the vertices.

Furthermore, a target file size for the 3D model is received (step S2). The target file size is a desired file size of the virtual 3D model.

As illustrated in FIG. 4, the computer program stored on the storage medium 16 of the server 14 can have a user interface 24 for setting the target file size.

This user interface 24 is for example displayed in an (Internet) browser of the smart device 12 so that the user can access the functions of the computer program without any software installed on the smart device 12.

The user interface 24 comprises a sliding control 26 by means of which the target file size can be set.

The target file size can be freely adjusted in predefined steps by means of the sliding control 26.

In the illustrated example embodiment of the user interface 24 of FIG. 4, the target file size can be set between 1 MB and 25 MB, file sizes of more than MB or less than 1 MB being however of course also conceivable.

The maximum adjustable file size can depend on the file size of the model data transmitted from the smart device 12 to the server 14.

The computer program can determine the file size of the model data and for example set the maximum selectable target file size to the file size of the model data.

Furthermore, the sliding control 26 includes information texts 28 which identify a recommended file size for predefined applications. For example, the information text “AR” identifies a recommended file size for applications for the representation of augmented reality, while the information text “VR” identifies a recommended file size for applications for the representation of virtual reality.

A user of the computer system 10 can thus simply set the target file size by means of the sliding control and confirm his selection using a button 30.

As an alternative to the sliding control 26, the user interface 24 can also have a writable text box in which a user of the computer system 10 can enter the desired target file size.

Alternatively, the user interface 24 can also have a selection list, in particular a dropdown list from which the user can select the desired target file size.

Optionally, the user interface 24 may have an help button 32, wherein a help menu can be displayed to the user upon activation of the help button 32.

At least one characteristic parameter of the model data is determined (step S3).

Generally speaking, the at least one characteristic parameter is a parameter which permits an estimation of the change in the file size when compressing the data.

The at least one characteristic parameter more particularly comprises a file type of the model data, a file size of the model data, a file size per vertex, and/or a file size per texel.

The model data can be converted into a target file format to determine the at least one characteristic parameter. The target file format corresponds to the file format in which the compressed model data is to be output.

More particularly, the target file format can be selected by the user by means of the user interface 24.

If the at least one characteristic parameter comprises the file size per vertex, for example, i.e. the entire file size divided by the number of vertices, this parameter permits an estimation of how many vertices have to be removed from the 3D model 22 to obtain the target file size.

If the at least one characteristic parameter comprises the file size per texel, for example, i.e. the entire file size divided by the number of texels, this parameter permits an estimation of how much the resolution of the textures of the 3D model 22 has to be reduced to obtain the target file size.

A preliminary mesh resolution, a preliminary texture resolution and/or at least one preliminary texture map to be used are determined based on the target file size and the at least one characteristic parameter of the model data (step S4).

The preliminary mesh resolution, the preliminary texture resolution and the at least one preliminary texture map to be used are estimated values which are determined based on the at least one characteristic parameter of the model data.

It is thus first estimated how the parameters of the virtual 3D model, i.e. the mesh resolution, the textures resolution and the texture maps to be used, are to be adjusted to obtain the target file size.

The model data is compressed based on the preliminary mesh resolution, the preliminary texture resolution and/or the at least one preliminary texture map to be used, compressed model data being thus obtained (step S5).

As shown in FIG. 5, the mesh resolution of the polygon mesh 23 can be reduced when compressing the model data, more specifically to the preliminary mesh resolution.

The resulting polygon mesh 34 of the corresponding preliminary 3D model 35 thus has a smaller mesh resolution than the original polygon mesh 23.

As illustrated in FIGS. 6 and 7, the textures can be changed in different ways upon compression, the textures of a different virtual 3D model being represented here.

FIG. 6 shows by way of example a first set of textures 36 having 15 different textures which are each assigned to one of three different texture layers. Each of these texture layers is associated with a specific partial aspect of the virtual 3D model, with a primary color, lighting, surface reflections, surface roughness, surface orientation, transparency, non-transparency, etc., for example.

FIG. 7 shows a second set of textures 38 which still has five different textures. The second set of textures 38 corresponds to the textures of the compressed virtual 3D model.

To obtain the second set of textures 38 from the first of textures 36, individual texture layers associated with specific partial aspects of the virtual 3D model are for example removed or combined with each other.

Accordingly, a different mapping rule, in particular a less complex mapping rule can be selected for the individual textures.

Alternatively or additionally, the resolution of individual or of all texture layers can be reduced.

A file size of the compressed model data is determined and compared with the target file size (step S6).

If the file size of the compressed model data is smaller than the target file size by less than a predefined difference size, the model data is output, i.e. stored in the storage medium 16 and/or transmitted to the client-side smart device 12 (step S7).

The predefined difference size may be between 2% and 25% of the target file size, in particular between 5% and 20% of the target file size, for example 10% of the target file size.

The predefined difference size can also be adjustable so that a user can select the predefined difference size on his own. For example, the user can set the predefined size by means of the user interface 24.

If the file size of the compressed model data is smaller than the target file size by more than the predefined difference size, the compressed model data are up-scaled (step S8).

In this case, based on the compressed model data and based on the target file size, a further preliminary mesh resolution and/or a further preliminary texture resolution are determined and/or a further preliminary texture map to be used is selected.

The up-scaling of the compressed model data is then performed based on the further preliminary mesh resolution, the further preliminary texture resolution and/or the further preliminary texture map to be used. Therefore, if the file size of the compressed model data deviates too much downward from the target file size after the first compression iteration, the number of vertices and/or the texture resolution is/are increased, and/or the textures map(s) used is/are changed to higher-order textures or to more different textures.

If the file size of the compressed model data is larger than a target file size by more than a predefined difference size, the compressed model data is compressed again (step S9).

In this case, a further preliminary mesh resolution and/or a further preliminary texture resolution are determined and/or a further preliminary texture map to be used is selected based on the compressed model data and based on the target file size.

The re-compression is then performed based on the further preliminary mesh resolution, the further preliminary texture resolution and/or the further preliminary texture map to be used.

The predefined difference size can in this case be equal to 10% or 5%, for example.

Preferably, the compressed model data is compressed again if the file size of the compressed model data is larger than the target file size. In other words, the predefined difference size is thus equal to 0 in this case.

More particularly, it may also happen that the file size of the up-scaled model data is larger than the target file size. In this case, step S9 described above may be performed to compress the model data again.

Conversely, it may happen that the file size of the re-compressed model data is smaller than the target file size. In this case, step S8 described above can be performed to up-scale the model data again.

Accordingly, the model data is iteratively compressed and/or up-scaled and the file size of the model data thus iteratively brought to the target file size.

More particularly, the total number of iterations of step S8 and/or the total number of iterations of step S9 may be limited to a maximum number. In this way, the total computing time for compression of the model data is limited.

When the maximum number of iterations is reached, the model data is output, i.e. stored in the storage medium 16 and/or transmitted to the client-side smart device 12.

By means of the method described above, the file size of the 3D model is thus automatically reduced to a target file size which can be selected by the user.

However, a maximum possible quality of the 3D model is maintained. The model data is therefore not compressed more than necessary.

1. A method of compressing model data of a virtual 3D model, comprising:
a) receiving model data containing information about the virtual 3D model;
b) determining at least one characteristic parameter of the model data;
c) receiving a target file size for the 3D model, wherein the target file size is a desired file size of the 3D model;
d) determining a preliminary mesh resolution of a preliminary virtual 3D model, a preliminary texture resolution of the preliminary virtual 3D model and/or selecting at least one preliminary texture map to be used of the preliminary virtual 3D model based on the at least one characteristic parameter and based on the target file size; and
e) compressing the model data based on the preliminary mesh resolution, the preliminary texture resolution and/or the at least one preliminary texture map to be used, thus obtaining compressed model data.

2. The method according to claim 1, wherein the at least one characteristic parameter includes a file type of the model data, a file size of the model data, a file size per vertex and/or a file size per texel.

3. The method according to claim 1, further comprising determining a file size of the compressed model data and comparing with the target file size.

4. The method according to claim 3, if the file size of the compressed model data is greater than the target file size by more than a predefined difference size, further comprising:
f) determining a further preliminary mesh resolution of a further preliminary virtual 3D model, a further preliminary texture resolution of the further preliminary virtual 3D model and/or selecting a further preliminary texture map to be used of the further preliminary virtual 3D model based on the compressed model data and based on the target file size; and
g) compressing the model data based on the further preliminary mesh resolution, the further preliminary texture resolution and/or the further preliminary texture map to be used.

5. The method according to claim 4, characterized in that steps f) and g) are repeated several times, wherein a maximum number of iterations of steps f) and g) is limited to a predefined maximum value.

6. The method according to claim 5, further comprising outputting the compressed model data when the maximum number of iterations is reached.

7. The method according to claim 3, if the file size of the compressed model data is smaller than the target file size by more than a predefined difference size, further comprising:
h) determining a further preliminary mesh resolution of a further preliminary virtual 3D model, a further preliminary texture resolution of the further preliminary virtual 3D model and/or selecting a further preliminary texture map to be used of the further preliminary virtual 3D model based on the compressed model data and based on the target file size; and
i) up-scaling the model data based on the further preliminary mesh resolution, the further preliminary texture resolution and/or the further preliminary texture map to be used.

8. The method according to claim 7, wherein the predefined difference size is between 2% and 25% of the target file size.

9. The method according to claim 8, wherein the predefined difference size is between 5% and 20% of the target file size.

10. The method according to claim 7, wherein steps h) and i) are limited to repeating to a predefined maximum value.

11. The method according to claim 10, further comprising outputting the compressed model data when the maximum number of iterations is reached.

12. The method according to claim 1, further comprising converting the model data into a target file format to determine the at least one characteristic parameter.

13. A computer system including at least one computing apparatus, wherein the computing apparatus includes at least one computing module configured with program code to:
a) receive model data containing information about a virtual 3D model;
b) determine at least one characteristic parameter of the model data;
c) receive a target file size for the 3D model;
d) determine a preliminary mesh resolution of a preliminary virtual 3D model, a preliminary texture resolution of the preliminary virtual 3D model and/or select at least one preliminary texture map to be used of the preliminary virtual 3D model based on the at least one characteristic parameter and based on the target file size; and
e) compress the model data based on the preliminary mesh resolution, the preliminary texture resolution and/or the at least one preliminary texture map to be used, thus obtaining compressed model data.

14. The computer system according to claim 13, wherein the at least one computing apparatus comprises at least one server.

15. The computer system according to claim 13, wherein the computer system further comprises a client-side smart device arranged to transmit the model data and/or the target file size to the computing apparatus.

16. (canceled)

17. (canceled)

18. (canceled)

19. A storage medium having computer-executable instructions to:
a) receive model data containing information about a virtual 3D model;
b) determine at least one characteristic parameter of the model data;
c) receive a target file size for the 3D model;
d) determine a preliminary mesh resolution of a preliminary virtual 3D model, a preliminary texture resolution of the preliminary virtual 3D model and/or select at least one preliminary texture map to be used of the preliminary virtual 3D model based on the at least one characteristic parameter and based on the target file size; and
e) compress the model data based on the preliminary mesh resolution, the preliminary texture resolution and/or the at least one preliminary texture map to be used, thus obtaining compressed model data.

20. The storage medium according to claim 19, wherein the at least one characteristic parameter includes a file type of the model data, a file size of the model data, a file size per vertex and/or a file size per texel.

21. The storage medium according to claim 19, further having stored thereon computer-executable instructions to determine a file size of the compressed model data and compare with the target file size.

22. The storage medium according to claim 21, further having stored thereon at least one of:
first computer-executable instructions to, if the file size of the compressed model data is greater than the target file size by more than a predefined difference size,
f) determine a further preliminary mesh resolution of a further preliminary virtual 3D model, a further preliminary texture resolution of the further preliminary virtual 3D model and/or select a further preliminary texture map to be used of the further preliminary virtual 3D model based on the compressed model data and based on the target file size; and
g) compress the model data based on the further preliminary mesh resolution, the further preliminary texture resolution and/or the further preliminary texture map to be used; and
second computer-executable instructions to, if the file size of the compressed model data is smaller than the target file size by more than a predefined difference size,
h) determining a further preliminary mesh resolution of a further preliminary virtual 3D model, a further preliminary texture resolution of the further preliminary virtual 3D model and/or selecting a further preliminary texture map to be used of the further preliminary virtual 3D model based on the compressed model data and based on the target file size; and
i) up-scaling the model data based on the further preliminary mesh resolution, the further preliminary texture resolution and/or the further preliminary texture map to be used.

23. The storage medium according to claim 22, wherein the first computer-executable instructions limit repeating of f) and g) to a predefined maximum value and the second computer-executable instructions limit repeating of h) and i) to the predefined maximum value.

24. The storage medium according to claim 23, further having stored thereon computer-executable instructions to output the compressed model data when the maximum number of iterations is reached.

25. The storage medium according to claim 22, wherein the predefined difference size is between 2% and 25% of the target file size or between 5% and 20% of the target file size.

26. The storage medium according to claim 19, further having stored thereon computer-executable instructions to convert the model data into a target file format to determine the at least one characteristic parameter.
